(19) United States
(12) Patent Application Publication
(10) Pub. No.: US 2026/0131860 A1
(43) Pub. Date: May 14, 2026

(54) FRONT PILLAR MEMBER

(71) Applicant: FUTABA INDUSTRIAL CO., LTD., Okazaki-shi (JP)

(72) Inventor: Yuya Miyanaga, Okazaki-shi (JP)

(21) Appl. No.: 19/360,091

(22) Filed: Oct. 16, 2025

(30) Foreign Application Priority Data
Nov. 14, 2024 (JP) 2024-199017

(51) Int. Cl. B62D 25/04; B62D 27/02

(52) U.S. Cl. CPC B62D 25/04; B62D 27/02

(57) ABSTRACT

A front pillar member of a vehicle includes a top plate, an upper side wall, a lower side wall; a front-end upper side wall, a front-end lower side wall, and a front-end top plate that include respective parts of a front end of the front pillar member; a main-body upper side wall; and a divisional section and a base section. The divisional section includes the front end of the front pillar member partially. The base section is a portion of the front pillar member other than the divisional section. A dividing line that forms a boundary between the divisional section and the base section crosses the upper side wall either on a boundary between the main-body upper side wall and the front-end upper side wall or an area, of the main-body upper side wall, in proximity to the boundary.

### CROSS-REFERENCE TO RELATED APPLICATIONS

This application claims the benefit of Japanese Patent Application No. 2024-199017 filed on November 14, 2024 with the Japan Patent Office, the entire disclosure of which is incorporated herein by reference.

### BACKGROUND

The present disclosure relates to a front pillar member, which is included in a front pillar of a vehicle.

A front pillar disclosed in Japanese Unexamined Patent Application Publication No. 2013-230803 consists of several members including a pillar inner panel and a pillar outer panel. The pillar inner panel is formed by joining a pillar inner panel upper and a pillar inner panel lower together. More specifically, the pillar inner panel upper, which has an extended portion at a lower end portion thereof, and the pillar inner panel lower, which also has an extended portion at an upper end portion thereof, are joined together with their extended portions overlapping each other. This configuration makes it possible to increase strength of a vehicle body without using a reinforcing member, resulting in reduced manufacturing costs.

### SUMMARY

However, the pillar inner panel disclosed in Japanese Unexamined Patent Application Publication No. 2013-230803 includes an elongated main body and an enlarged diameter portion. The enlarged diameter portion is located at a lower end of the elongated main body and has a greater cross-sectional area than the main body. The extended portions that join the pillar inner panel upper and the pillar inner panel lower together are positioned in an area, of the elongated main body, in proximity to the enlarged diameter portion. Such a configuration may cause stress to be concentrated on the extended portions at the time of a vehicle collision or similar event, resulting in damage and decreased collision performance of the vehicle.

In one aspect of the present disclosure, it is desirable to reduce manufacturing costs of the vehicle while inhibiting decrease in collision performance of the vehicle.

One aspect of the present disclosure is a front pillar member that is included in a front pillar of a vehicle and that extends from a front end to a back end of the front pillar member, the front pillar member including a top plate, an upper side wall, a lower side wall, a front-end upper side wall, a main-body upper side wall, a front-end lower side wall, a front-end top plate, a main-body top plate, a divisional section, a base section, and a dividing line. The top plate is a plate-shaped portion extending from the front end to a side where the back end is located. The upper side wall protrudes from a first end, in width directions, of the top plate and extends from the front end to the side where the back end is located. The lower side wall protrudes from a second end, in the width directions, of the top plate and extends from the front end to the side where the back end is located, facing the upper side wall in a position below the upper side wall. The front-end upper side wall is a part of the upper side wall, including a part of the front end and curving downward. The main-body upper side wall is a part of the upper side wall and adjoins the front-end upper side wall on a side of the front-end upper side wall closer to the back end. The front-end lower side wall is a part of the lower side wall, including a part of the front end and curving downward. The front-end top plate is a part of the top plate, including a part of the front end and being located between the front-end upper side wall and the front-end lower side wall. The main-body top plate is a part of the top plate and adjoins the front-end top plate on a side of the front-end top plate closer to the back end. The divisional section is a section of the front pillar member, including the front end partially. The base section is a section of the front pillar member other than the divisional section. The dividing line forms a boundary between the divisional section and the base section. A width of the front-end top plate is wider than a width of the main-body top plate. The upper side wall includes a root portion and an edge portion. The root portion is an end portion, of the upper side wall, adjacent to the top plate. The edge portion is an end portion, of the upper side wall, opposite the root portion. The dividing line crosses the upper side wall from the edge portion to the root portion either on a boundary between the main-body upper side wall and the front-end upper side wall or on an area, of the main-body upper side wall, in proximity to the boundary, and further extends either to the part of the front end included in the top plate or to the part of the front end included in the lower side wall.

According to the aforementioned configuration, the front pillar member can be formed by separately forming the divisional section and the base section through a bending process, and then joining them together. In this way, compared to a case of forming the front pillar member through a drawing process, a yield is improved. Additionally, since the dividing line passes a wider area of a front end portion of the front pillar member, it is possible to reduce concentration of stress on the dividing line and, as a result, to inhibit damage to the dividing line. Accordingly, this configuration makes it possible to reduce the manufacturing costs while inhibiting decrease in collision performance of the vehicle, in the front pillar member.

In one aspect of the present disclosure, the dividing line may cross the upper side wall from the edge portion to the root portion on the area, of the main-body upper side wall, in proximity to the boundary between the main-body upper side wall and the front-end upper side wall and may further extend to the part of the front end included in the top plate.

According to the aforementioned configuration, it is possible to reduce the manufacturing costs while inhibiting decrease in collision performance of the vehicle, in the front pillar member.

In one aspect of the present disclosure, the lower side wall may include a joint portion to which a member included in a center-pillar of the vehicle is to be joined.

According to the aforementioned configuration, a back end of the front pillar member may be arranged rearward of a driver seat and a front passenger seat in the vehicle. With this configuration, even if the front pillar member is bent inside the vehicle due to a collision, it is possible to inhibit damage to a person in the driver seat or the front passenger seat.

One aspect of the present disclosure further includes a flange portion that protrudes from an end portion, of the lower side wall, on a side opposite where the top plate is located toward a side opposite where the upper side wall is located.

According to the aforementioned configuration, it is possible to reduce the manufacturing costs while inhibiting decrease in collision performance of the vehicle, in the front pillar member.

In one aspect of the present disclosure, the base section may be made of high tensile strength steel with a tensile strength of 980 MPa or more.

The aforementioned configuration can result in improvement of strength of the front pillar member.

In one aspect of the present disclosure, a material of the divisional section may have a lower tensile strength than a material of the base section.

In one aspect of the present disclosure, the divisional section may be thicker than the base section.

In one aspect of the present disclosure, the divisional section and the base section may be welded together.

According to the aforementioned configurations, it is possible to reduce the manufacturing costs while inhibiting decrease in collision performance of the vehicle, in the front pillar member

In one aspect of the present disclosure, the front-end upper side wall may include a beveling portion that extends in a substantially planar shape. The beveling portion may be located in proximity to a boundary between the front-end upper side wall and the main-body upper side wall, and may be adjacent to the top plate. The dividing line does not necessarily have to pass through the beveling portion.

The aforementioned configuration can inhibit decrease in strength of the beveling portion.

### BRIEF DESCRIPTION OF THE DRAWINGS

An example embodiment of the present disclosure will be described hereinafter with reference to the accompanying drawings, in which:

FIG. 1 is a front view of a front pillar to which a center pillar is joined;

FIG. 2A is a front view of a front end of a front pillar member and its surroundings;

FIG. 2B is a perspective view of the front end of the front pillar member and its surroundings;

FIG. 3A is a cross-sectional view of a part taken along a line IIIA-IIIA in FIG. 2A (in other words, a cross-sectional view of a front end portion of the front pillar member); and

FIG. 3B is a cross-sectional view of a part taken along a line IIIB-IIIB in FIG. 2A (in other words, a cross-sectional view of a main body of the front pillar member).

### DETAILED DESCRIPTION OF EXEMPLARY EMBODIMENTS

### 1. Overview

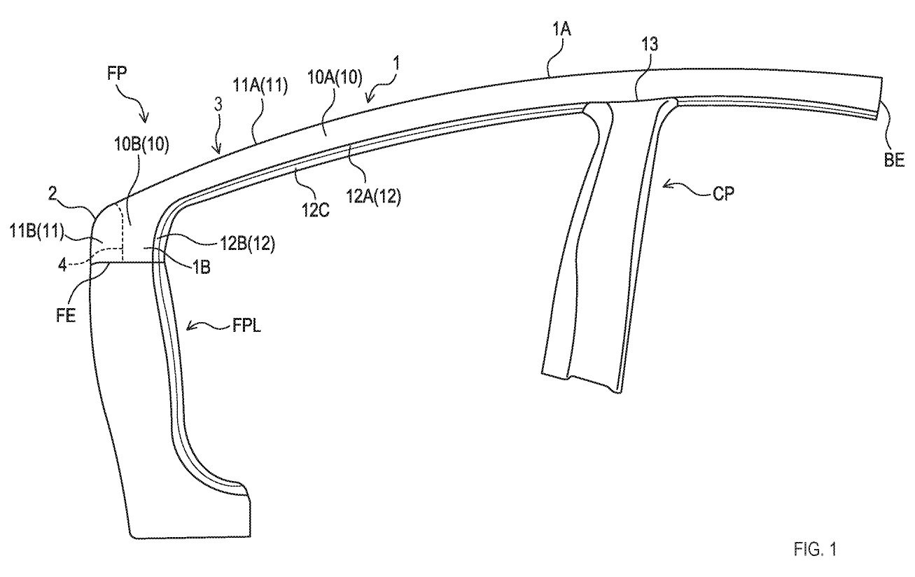

A front pillar member 1 is made of a metal material and is an elongated member that extends from a front end FE to a back end BE of the front pillar member 1. The front pillar member 1 is included in a front pillar FP that forms a part of a vehicle body (see FIG. 1). The front pillar FP comprises the front pillar member 1 and a front pillar lower FPL, which is an elongated member extending in up-down directions. An upper end of the front pillar lower FPL is joined to the front end FE of the front pillar member 1. In addition, an upper end of a center pillar CP is joined to the front pillar member 1 at a position between the front end FE and the back end BE. The details of this joining will be described below. The center pillar CP is an elongated member extending in the up-down directions and is positioned rearward of a driver door or a front passenger door in the vehicle body.

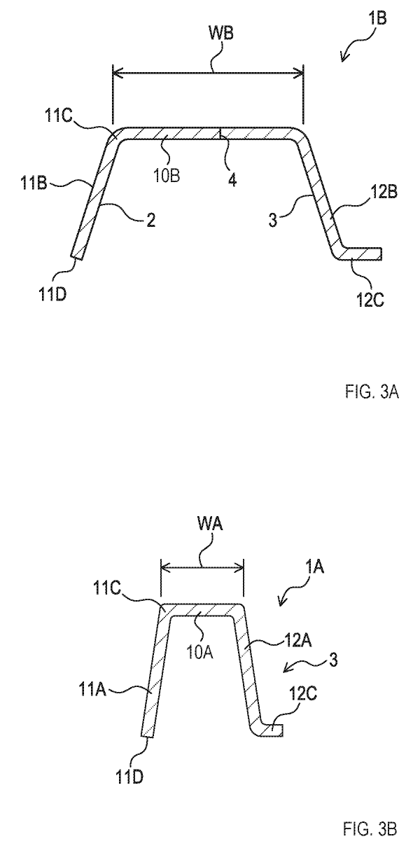

The front pillar member 1 comprises a main body 1A and a front end portion 1B. The front end portion 1B adjoins the main body 1A at a front side of the main body 1A (see FIGS. 1, 2A, 3A, and 3B). The main body 1A extends in front-rear directions of the vehicle body and slopes upward toward a side where the back end BE is located relative to horizontal directions. The front end portion 1B includes the front end FE of the front pillar member 1 and curves downward. In addition, a cross-section orthogonal to extending directions of the front pillar member 1 (hereinafter simply called the cross-section) in the front end portion 1B is larger than the cross-section in the main body 1A.

The front pillar member 1 comprises a top plate 10, an upper side wall 11, a lower side wall 12, and a joint portion 13, and the top plate 10, the upper side wall 11, and the lower side wall 12 are provided across the main body 1A and the front end portion 1B. Furthermore, as one example, the front pillar member 1 consists of a divisional section 2 and a base section 3. However, without being limited to this, the front pillar member 1 may comprise a plurality of members including the divisional section 2 and the base section 3.

### 2. Top plate

The top plate 10 is an elongated plate-shaped portion that extends from the front end FE to the back end BE and has a width extending in substantially up-down directions (see FIGS. 1, 2A, 3A, and 3B). The top plate 10 comprises a main-body top plate 10A, which is included in the main body 1A, and a front-end top plate 10B, which is included in the front end portion 1B.

The main-body top plate 10A adjoins the front-end top plate 10B on a side of the front-end top plate 10B closer to the back end BE and extends from the front-end top plate 10B to the back end BE.

The front-end top plate 10B includes a part of the front end FE and is positioned between a front-end upper side wall 11B and a front-end lower side wall 12B, which will be described below. The front-end top plate 10B extends to curve downward from a front end of the main-body top plate 10A. A width WB of the front-end top plate 10B is wider than a width WA of the main-body top plate 10A. Note that the width refers to a length, in width directions W, of the top plate 10, which directions are substantially orthogonal to extending directions of the top plate 10.

### 3. Upper Side Wall

The upper side wall 11 is a plate-shaped portion that protrudes from a first end, in the width directions W, of the top plate 10 (in other words, an upper end of the top plate 10), and extends from the front end FE to the back end BE (see FIGS. 1, 2A, 3A, and 3B). The upper side wall 11 comprises a main-body upper side wall 11A, which is included in the main body 1A, and a front-end upper side wall 11B, which is included in the front end portion 1B, a root portion 11C, an edge portion 11D, and a beveling portion 11E.

The main-body upper side wall 11A adjoins the front-end upper side wall 11B on a side of the front-end upper side wall 11B closer to the back end BE.

The front-end upper side wall 11B includes a part of the front end FE and extends to curve downward from a front end of the main-body upper side wall 11A.

The root portion 11C is an end portion, of the upper side wall 11, adjacent to the top plate 10.

The edge portion 11D is an end portion, of the upper side wall 11, opposite the root portion 11C.

### 4. Beveling Portion

The beveling portion 11E is a portion that is provided on the front-end upper side wall 11B, and extends in a substantially planar shape. The beveling portion 11E is located in proximity to a boundary between the main-body upper side wall 11A and the front-end upper side wall 11B, and is adjacent to the root portion 11C (in other words, adjacent to the top plate 10). In other words, the beveling portion 11E is provided on a curving area of the front-end upper side wall 11B.

As one example, the beveling portion 11E is provided on only the front-end upper side wall 11B and is adjacent to the boundary between the main-body upper side wall 11A and the front-end upper side wall 11B. However, the beveling portion 11E may be positioned apart from the boundary, in the front-end upper side wall 11B. Alternatively, the beveling portion 11E may be provided to extend over the front-end upper side wall 11B and the main-body upper side wall 11A.

As one example, the beveling portion 11E is positioned apart from the edge portion 11D; however, the beveling portion 11E may be adjacent to the edge portion 11D. Alternatively, the front pillar member 1 does not necessarily have to have the beveling portion 11E.

### 5. Lower Side Wall

The lower side wall 12 is a plate-shaped portion that protrudes from a second end, in the width directions W, of the top plate 10 (in other words, a lower end of the top plate 10) ,and extends from the front end FE to the back end BE (see FIGS. 1, 2A, 3A, and 3B). The lower side wall 12 is located in a position below the upper side wall 11 and faces the upper side wall 11 in the width directions W of the top plate 10. The lower side wall 12 comprises a main-body lower side wall 12A, which is included in the main body 1A, and a front-end lower side wall 12B, which is included in the front end portion 1B, and a flange portion 12C.

The main-body lower side wall 12A adjoins the front-end lower side wall 12B on a side of the front-end lower side wall 12B closer to the back end BE.

The front-end lower side wall 12B includes a part of the front end FE and extends to curve downward from a front end of the main-body lower side wall 12A.

The flange portion 12C is a flange-shaped portion provided on the lower side wall 12, and extends from the front end FE to the back end BE. Specifically, the flange portion 12C is provided on an end, of the lower side wall 12, on a side opposite where the top plate 10 is located, and protrudes toward a side opposite where the upper side wall 11 is located.

### 6. Joint Portion

The joint portion 13 is a portion where an upper end of the center-pillar CP is to be joined (see FIG. 1). As one example, the joint portion 13 is provided on the main-body lower side wall 12A and positioned at a specified distance from the back end BE. However, without being limited to this, the joint portion 13 may be provided adjacent to the back end BE. Alternatively, the joint portion 13 may be positioned to extend over the main-body top plate 10A and the main-body lower side wall 12A, for example. Needless to say, the front pillar member 1 does not necessarily have to have the joint portion 13.

### 7. Divisional section and Base Section

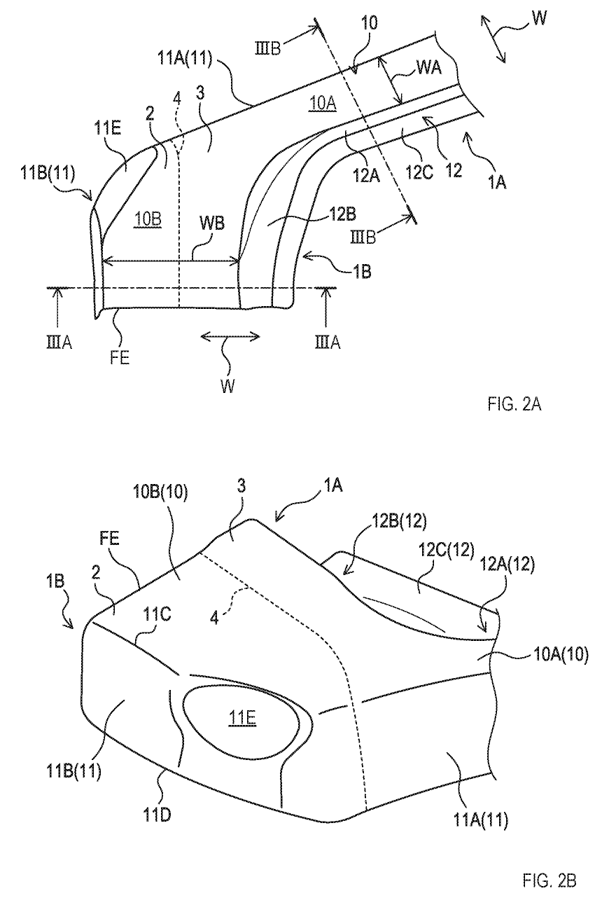

The divisional section 2 is a section of the front pillar member 1 that includes a part of the front end FE, and is located on the front end portion 1B (see FIGS. 1 to 2B). Note that the divisional section 2 may be positioned to extend over the front end portion 1B and an area, of the main body 1A, in proximity to a boundary with the front end portion 1B. The base section 3 is a section of the front pillar member 1 other than the divisional section 2.

In the present embodiment, as one example, the divisional section 2 is made of a metal material having a lower tensile strength than the base section 3. Needless to say, without being limited to this, the tensile strength of the metal material of the divisional section 2 may be the same as the tensile strength of the metal material of the base section 3, or the divisional section 2 may be made of a metal material having a higher tensile strength than the base section 3.

In the present embodiment, as one example, a material of the base section 3 may be high tensile strength steel with a tensile strength of 980 MPa or more, may be high tensile strength steel with tensile strength of 1,180 MPa or more, or may be high tensile strength steel with tensile strength of 1,470 MPa or more. Needless to say, the material may be steel, iron, or other metal.

In the present embodiment, as one example, the divisional section 2 is thicker than the base section 3. However, without being limited to this, the divisional section 2 and the base section 3 may have the same plate thickness, or the divisional section 2 may be thinner than the base section 3.

The front pillar member 1 is formed by welding an end portion of the divisional section 2 and an end portion of the base section 3 to each other. Note that the end portion of the divisional section 2 and the end portion of the base section 3 may be welded to each other in an overlapping state. Alternatively, an end face of the divisional section 2 and an end face of the base section 3 may be welded to each other by butt welding. The end portion of the divisional section 2 and the end portion of the base section 3 may be joined together by a method other than welding.

### 8. Dividing Line

A dividing line 4, which forms a boundary between the divisional section 2 and the base section 3, crosses the upper side wall 11 from the edge portion 11D to the root portion 11C either on a boundary, in the main-body upper side wall 11A, with the front-end upper side wall 11B or on an area, of the main-body upper side wall 11A, in proximity to the boundary (see FIGS. 2A and 2B), as one example. The dividing line 4 further extends from an end portion, of the top plate 10, adjacent to the upper side wall 11 either to the part of the front end FE included in the top plate 10 or to the part of the front end FE included in the lower side wall 12.

More specifically, the dividing line 4 passes through the main-body top plate 10A and the front-end top plate 10B, and extends either to the part of the front end FE included in the front-end top plate 10B or to the part of the front end FE included in the lower side wall 12, as one example. Alternatively, without passing through the main-body top plate 10A, the dividing line 4 may pass through the front-end top plate 10B and extend either to the part of the front end FE included in the front-end top plate 10B or to the part of the front end FE included in the lower side wall 12.

The dividing line 4 passing through the top plate 10 extends substantially linearly along a direction substantially coincident with the up-down directions, as one example. Without being limited to this, the dividing line 4 may be inclined relative to the up-down directions or may have a curved shape. Further, the dividing line 4 may be arranged to pass through a boundary between the front-end top plate 10B and the front-end upper side wall 11B or in proximity to the boundary, for example.

The dividing line 4 is arranged to avoid the beveling portion 11E and does not pass through the beveling portion 11E. However, without being limited to this, the dividing line 4 may be partially located in the beveling portion 11E.

### 9. Manufacturing Method of Front Pillar Member

A method of manufacturing the front pillar member 1 includes a pressing process, where press forming is performed, and a joining process.

In the pressing process, the divisional section 2 is formed by bending a first plate material, and the base section 3 is formed by bending a second plate material. Note that the first and second plate materials may be either blank materials or plate materials on which press forming has already been performed.

In the joining process, the end portion of the divisional section 2 and the end portion of the base section 3 are welded to each other, thereby forming the front pillar member 1. Specifically, the end portion of the divisional section 2 and the end portion of the base section 3 may be overlapped with each other, and spot-welding may be performed on the overlapped part, for example. Besides this method, butt welding may be performed to weld the end face of the divisional section 2 and the end face of the base section 3 to each other, for example. These end portions may be joined to each other using a method other than welding.

### 10. Effects

(1) The front end portion 1B of the front pillar member 1 according to the aforementioned embodiment has a so-called pocket shape. When forming the front pillar member 1 by bending a single plate material, the material flows toward the beveling portion 11E on the front end portion 1B, and thus wrinkles are likely to occur around the beveling portion 11E on the front end portion 1B. On the other hand, when forming the front pillar member 1 by drawing a plate material, the occurrence of such wrinkles can be inhibited; however, a clamping allowance, which is a portion to be held by a blank holder, needs to be provided on the plate material. For this reason, the plate material cannot be used effectively in its entirety, resulting in a decrease in yield.

In contrast, according to the aforementioned embodiment, the front pillar member 1 can be formed by separately forming the divisional section 2 and the base section 3, which do not have a bag shape like the front end portion 1B, through the bending process and by joining the divisional section 2 and the base section 3 together. With this manufacturing method, the occurrence of wrinkles can be inhibited, and the yield can be improved compared to a case where the drawing process is performed. Additionally, since the dividing line 4 passes through a wider part of the front pillar member 1, that is, the front end portion 1B, it is possible to reduce concentration of stress on the dividing line 4 and, as a result, to inhibit damage to the dividing line 4. Accordingly, this configuration makes it possible to reduce the manufacturing costs while inhibiting decrease in collision performance of the vehicle, in the front pillar member 1.

(2) When forming the front pillar member 1 by drawing a plate material, clamping allowance needs to be provided on the plate material, and thus a length of the main body 1A is limited. For this reason, an additional member may be welded to the back end BE of the front pillar member 1 to secure a length of the front pillar member 1. However, at the time of a vehicle collision, the joint portion between the front pillar member 1 and the additional member may be damaged, and thus adding the additional member could result in decrease in collision performance of the front pillar member 1.

However, according to the aforementioned embodiment, the base section 3 is formed by bending the plate material. Thus, there is no need to provide the clamping allowance on the plate material, which makes it possible to form a longer main body 1A. As a result, it is possible to provide the joint portion 13, to which a member of the center-pillar CP is to be joined, on the main-body lower side wall 12A of the front pillar member 1.

According to this configuration, it is no longer necessary to use the additional member to secure a longer length of the front pillar member 1, and thus the collision performance of the front pillar member 1 is improved. Additionally, the back end BE of the front pillar member 1 can be positioned rearward of a driver seat and a front passenger seat in the vehicle. As a result, even when the front pillar member 1 is bent sharply inside the vehicle due to a collision, it is possible to inhibit the back end of the front pillar member 1 from projecting toward the driver seat or the front passenger seat and to inhibit damage to a person in the driver seat or the front passenger seat.

(3) The base section 3 is made of high tensile strength steel with a tensile strength of 980 MPa or more. Thus, the strength of the front pillar member 1 can be improved. Furthermore, while using the high tensile strength steel to form the front pillar member 1, since the front pillar member 1 is formed from the divisional section 2 and the base section 3, it is possible to inhibit the occurrence of wrinkles during the bending process.

(4) The front-end upper side wall 11B includes the beveling portion 11E. This configuration can inhibit damage to the front pillar member 1 at the time of a vehicle collision. Moreover, the dividing line 4 is arranged to avoid the beveling portion 11E. This configuration can inhibit reduction in strength of the beveling portion 11E.

### 11. Other Embodiments

(1) In the aforementioned embodiment, the flange portion 12C is provided on the lower side wall 12; however, the flange portion 12C does not necessarily have to be provided on the lower side wall 12. In the aforementioned embodiment, the upper side wall 11 is not provided with a flange portion; however, the edge portion 11D of the upper side wall 11 may be provided with a flange portion that projects toward a side opposite where the lower side wall 12 is located.

(2) Two or more functions of a single element in the above-described embodiments may be achieved by two or more elements or a single function of a single element may be achieved by two or more elements. The functions of two or more elements may be achieved by a single element, or a single function of two or more elements may be achieved by a single element. Part of the configuration in the above-described embodiments may be omitted. Furthermore, at least part of the configuration of the above-described embodiments may be added to or replaced by a configuration of other embodiments.

### 12. Technical Ida Disclosed in Present Invention

### Item 1

A front pillar member that is included in a front pillar of a vehicle and that extends from a front end to a back end of the front pillar member, the front pillar member comprising: a top plate that is a plate-shaped portion extending from the front end to a side where the back end is located; an upper side wall that protrudes from a first end, in width directions, of the top plate and that extends from the front end to the side where the back end is located; a lower side wall that protrudes from a second end, in the width directions, of the top plate and that extends from the front end to the side where the back end is located, the lower side wall facing the upper side wall in a position below the upper side wall; a front-end upper side wall that is a part of the upper side wall, the front-end upper side wall including a part of the front end and curving downward; a main-body upper side wall that is a part of the upper side wall, the main-body upper side wall adjoining the front-end upper side wall on a side of the front-end upper side wall closer to the back end; a front-end lower side wall that is a part of the lower side wall, the front-end lower side wall including a part of the front end and curving downward; a front-end top plate that is a part of the top plate, the front-end top plate including a part of the front end and being located between the front-end upper side wall and the front-end lower side wall; a main-body top plate that is a part of the top plate, the main-body top plate adjoining the front-end top plate on a side of the front-end top plate closer to the back end; a divisional section that is a section of the front pillar member, the divisional section including the front end partially; a base section that is a section of the front pillar member other than the divisional section; and a dividing line forming a boundary between the divisional section and the base section, a width of the front-end top plate being wider than a width of the main-body top plate, the upper side wall including a root portion that is an end portion, of the upper side wall, adjacent to the top plate and an edge portion that is an end portion, of the upper side wall, opposite the root portion, and the dividing line crossing the upper side wall from the edge portion to the root portion either on a boundary between the main-body upper side wall and the front-end upper side wall or on an area, of the main-body upper side wall, in proximity to the boundary, the dividing line further extending either to the part of the front end included in the top plate or to the part of the front end included in the lower side wall.

### Item 2

The front pillar member according to item 1, wherein the lower side wall includes a joint portion to which a member included in a center-pillar of the vehicle is to be joined.

### Item 3

The front pillar member according to item 1 or 2, wherein the base section is made of high tensile strength steel with a tensile strength of 980 MPa or more.

### Item 4

The front pillar member according to any one of items 1 through 3, wherein the front-end upper side wall includes a beveling portion that extends in a substantially planar shape, wherein the beveling portion is located in proximity to a boundary between the front-end upper side wall and the main-body upper side wall and is adjacent to the top plate, and wherein the dividing line does not pass through the beveling portion.

What is claimed is:

1. A front pillar member that is included in a front pillar of a vehicle and that extends from a front end to a back end of the front pillar member, the front pillar member comprising:
a top plate that is a plate-shaped portion extending from the front end to a side where the back end is located;
an upper side wall that protrudes from a first end, in width directions, of the top plate and that extends from the front end to the side where the back end is located;
a lower side wall that protrudes from a second end, in the width directions, of the top plate and that extends from the front end to the side where the back end is located, the lower side wall facing the upper side wall in a position below the upper side wall;
a front-end upper side wall that is a part of the upper side wall, the front-end upper side wall including a part of the front end and curving downward;
a main-body upper side wall that is a part of the upper side wall, the main-body upper side wall adjoining the front-end upper side wall on a side of the front-end upper side wall closer to the back end;
a front-end lower side wall that is a part of the lower side wall, the front-end lower side wall including a part of the front end and curving downward;
a front-end top plate that is a part of the top plate, the front-end top plate including a part of the front end and being located between the front-end upper side wall and the front-end lower side wall;
a main-body top plate that is a part of the top plate, the main-body top plate adjoining the front-end top plate on a side of the front-end top plate closer to the back end;
a divisional section that is a section of the front pillar member, the divisional section including the front end partially;
a base section that is a section of the front pillar member other than the divisional section; and
a dividing line forming a boundary between the divisional section and the base section,
a width of the front-end top plate being wider than a width of the main-body top plate,
the upper side wall including a root portion that is an end portion, of the upper side wall, adjacent to the top plate and an edge portion that is an end portion, of the upper side wall, opposite the root portion, and
the dividing line crossing the upper side wall from the edge portion to the root portion either on a boundary between the main-body upper side wall and the front-end upper side wall or on an area, of the main-body upper side wall, in proximity to the boundary, the dividing line further extending either to the part of the front end included in the top plate or to the part of the front end included in the lower side wall.

2. The front pillar member according to claim 1,
wherein the dividing line crosses the upper side wall from the edge portion to the root portion on the area, of the main-body upper side wall, in proximity to the boundary between the main-body upper side wall and the front-end upper side wall and further extends to the part of the front end included in the top plate.

3. The front pillar member according to claim 1,
wherein the lower side wall includes a joint portion to which a member included in a center-pillar of the vehicle is to be joined.

4. The front pillar member according to claim 1, further comprising:
a flange portion that protrudes from an end portion, of the lower side wall, on a side opposite where the top plate is located toward a side opposite where the upper side wall is located.

5. The front pillar member according to claim 1,
wherein the base section is made of high tensile strength steel with a tensile strength of 980 MPa or more.

6. The front pillar member according to claim 1,
wherein a material of the divisional section has a lower tensile strength than a material of the base section.

7. The front pillar member according to claim 1,
wherein the divisional section is thicker than the base section.

8. The front pillar member according to claim 1,
wherein the divisional section and the base section are welded together.

9. The front pillar member according to claim 1,
wherein the front-end upper side wall includes a beveling portion that extends in a substantially planar shape,
wherein the beveling portion is located in proximity to a boundary between the front-end upper side wall and the main-body upper side wall and is adjacent to the top plate, and
wherein the dividing line does not pass through the beveling portion.
